(19) United States
(12) Patent Application Publication
(10) Pub. No.: US 2024/0426669 A1
(43) Pub. Date: Dec. 26, 2024

(54) Temperature Sensor

(71) Applicant: FUTABA CORPORATION, Mobara-shi (JP)

(72) Inventors: Takashi INOUE, Mobara-shi (JP); Fumitaka MIYAO, Mobara-shi (JP); Ryosuke INADOME, Mobara-shi (JP)

(21) Appl. No.: 18/746,151

(22) Filed: Jun. 18, 2024

(30) Foreign Application Priority Data
Jun. 22, 2023 (JP) 2023-102410

(51) Int. Cl. G01J 5/0875; G01J 5/00; G01J 5/04; G01J 5/0821; G01J 5/12

(52) U.S. Cl. CPC G01J 5/0875; G01J 5/0037; G01J 5/048; G01J 5/0821; G01J 5/12

(57) ABSTRACT

Provided is a temperature sensor used in a molding machine, comprising a cylindrical fiber probe into which an optical fiber is inserted; a window support part formed in a cylindrical shape and into which at least a part of the fiber probe is inserted; a protective window disposed on a tip end side of the fiber probe while being at least partially inserted into the window support part; and a sleeve member formed in an annular shape, and having an inner circumferential surface in contact with an outer circumferential surface of the protective window and an outer circumferential surface in contact with an inner circumferential surface of the window support part.

### CROSS-REFERENCE TO RELATED APPLICATIONS

This application claims priority to Japanese Patent Application No. 2023-102410 filed on Jun. 22, 2023, the entire contents of which are incorporated herein by reference.

### TECHNICAL FIELD

The present disclosure relates to a technical field of a temperature sensor using an optical fiber used in a molding machine.

### BACKGROUND

A molding machine that molds a resin molded product is provided with a sensor for measuring a temperature or a pressure of a resin in a cavity or the like. Such a sensor may be, e.g., a temperature sensor that measures a temperature by connecting a fiber probe into which an optical fiber is inserted to a cavity, and transmitting infrared light emitted from molten resin filled in the cavity to a detector through the optical fiber (see, e.g., Japanese Laid-open Patent Publication No. 2008-232753).

In the above temperature sensor, a glass protective window is disposed on a tip end side of the fiber probe in order to measure a temperature of molten resin in a high temperature and high pressure environment, such as a nozzle of an injection molding machine (see e.g., Japanese Laid-open Patent Publication No. H1-124725).

A temperature sensor having such a protective window is provided with a window support part for supporting the protective window, and the window support part is generally made of a metal material. In the temperature sensor disclosed in Japanese Laid-open Patent Publication No. H1-124725, the protective window made of rod-shaped sapphire glass is inserted and fixed into a cylindrical window support part (metal cover).

### SUMMARY

In the above temperature sensor, the temperature sensor may be heated by heat emitted from the molding machine during measurement, and the window support part or the protective window may be expanded. In this case, a gap may be generated between the protective window and the window support part, and the molten resin may enter the generated gap. If the molten resin enters the gap between the protective window and the window support part, when the temperature sensor is cooled, the resin that has entered the gap may be pressed against the protective window by the contraction of the window support part. Accordingly, an excessive force may be applied to the protective window, and the protective window may be damaged.

Therefore, an object of the present disclosure is to prevent damage to a protective window.

In accordance with an aspect of the present disclosure, there is provided a temperature sensor used in a molding machine, comprising: a cylindrical fiber probe into which an optical fiber is inserted; a window support part formed in a cylindrical shape and into which at least a part of the fiber probe is inserted; a protective window disposed on a tip end side of the fiber probe while being at least partially inserted into the window support part; and a sleeve member formed in an annular shape, and having an inner circumferential surface in contact with an outer circumferential surface of the protective window and an outer circumferential surface in contact with an inner circumferential surface of the window support part.

Accordingly, the sleeve member is positioned between the protective window and the window support part.

### BRIEF DESCRIPTION OF THE DRAWINGS

FIG. 1, which illustrates an embodiment of the present disclosure together with FIGS. 2 and 4, is a cross-sectional view of a temperature sensor.

FIG. 2 is an enlarged cross-sectional view showing a part of the temperature sensor.

FIG. 3 is an enlarged cross-sectional view showing an example in which a thermocouple is attached to a protective window.

FIG. 4 is an enlarged cross-sectional view showing an example in which a spacer is supported by the protective window.

### DETAILED DESCRIPTION

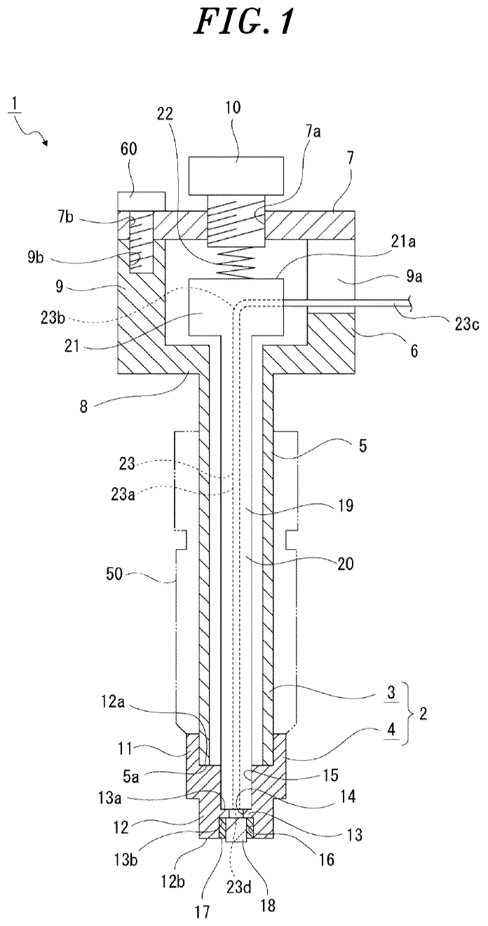

Hereinafter, embodiments for implementing a temperature sensor of the present disclosure will be described with reference to the accompanying drawings (see FIGS. 1 to 4).

A temperature sensor to be described below has a cylindrical fiber probe. In the following description, upper, lower, right, and left sides are defined by setting the axial direction of the fiber probe to the vertical direction and setting the tip end side of the fiber probe to the lower side. However, the upper, lower, right, and left sides in the following description are defined for convenience of description, and the embodiments of the present disclosure are not limited to these directions.

### Temperature Sensor According to First Embodiment

First, a temperature sensor 1 according to a first embodiment will be described (see FIGS. 1 to 3).

The temperature sensor 1 is attached to an injection molding machine (not shown), and is used for measuring a temperature of molten resin in a nozzle, for example. Further, the molding machine to which the temperature sensor 1 is attached is not limited to an injection molding machine, and the temperature sensor 1 may be attached to an extrusion molding machine, a blow molding machine, or the like.

The required individual components of the temperature sensor 1 are disposed or supported in an outer case 2 (see FIG. 1). The outer case 2 has a housing 3 and a window support part 4. For example, individual components of the outer case 2 are made of a metal material.

The housing 3 has a shaft part 5, a placing part 6, and a lid part 7.

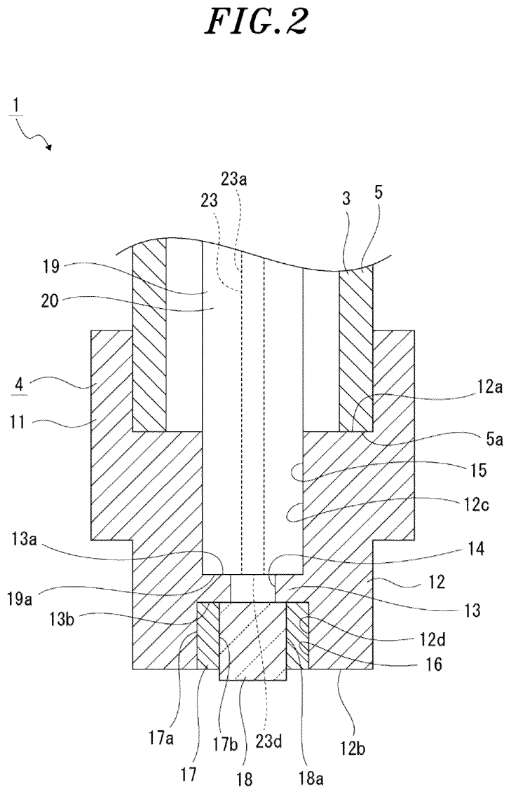

The shaft part 5 is formed in a cylindrical shape whose axial direction coincides with the vertical direction. An installation nut 50 for attaching the temperature sensor 1 to an injection molding machine is attached to a portion of the shaft part 5 except an upper end and a lower end thereof. The bottom surface of the shaft part 5 serves as a pressing surface 5a (see FIGS. 1 and 2).

The placing part 6 has a flange portion 8 projecting outward from the upper end of the shaft part 5, and a substantially cylindrical annular portion 9 projecting upward from the outer peripheral portion of the flange portion 8. The placing part 6 is formed integrally with the shaft part 5, for example. A notch 9a that is opened upward is formed in the annular portion 9 to penetrate therethrough in a radial direction. A plurality of mounting holes 9b that are opened upward are formed at the upper end of the annular portion 9 while being spaced apart from each other in a circumferential direction.

The lid part 7 is formed in an annular shape, and has a screw hole 7a at the center thereof. An adjusting screw 10 is screwed into the screw hole 7a. Screw insertion holes 7b are formed to vertically penetrate through the outer periphery of the lid part 7 while being spaced apart in the circumferential direction. The lid part 7 is attached to the placing part 6 from the top by screwing mounting screws 60 inserted through the screw insertion holes 7b into the mounting holes 9b.

The window support part 4 is formed in a cylindrical shape whose axial direction coincides with the vertical direction. The window support part 4 is made of, e.g., stainless steel, and has a thermal expansion coefficient (linear expansion coefficient) that is within a range of, e.g., 11.5×10-6/° C. to 12.5×10-6/° C.

The window support part 4 has a fixing portion 11, a holding portion 12, and a receiving portion 13. Both the fixing portion 11 and the holding portion 12 are formed in a cylindrical shape, and the diameter of the fixing portion 11 is larger than that of the holding portion 12. The holding portion 12 is continuously disposed from the lower end of the fixing portion 11 to a position below the fixing portion 11. The holding portion 12 has an upper surface serving as a pressed surface 12a and a bottom surface serving as a tip end surface 12b. The fixing portion 11 of the window support part 4 is attached from the outside to the lower end of the shaft part 5, and the pressing surface 5a of the shaft part 5 is pressed against the pressed surface 12a of the holding portion 12.

The receiving portion 13 projects inward at a vertically intermediate portion of the holding portion 12 (see FIG. 2). The upper surface of the receiving portion 13 serves as a first receiving surface 13a, and the bottom surface thereof serves as a second receiving surface 13b. The inner space of the receiving portion 13 serves as a through-hole 14. The diameter of the through-hole 14 is larger than that of an optical fiber to be described later. In the inner space of the holding portion 12, the space above the receiving portion 13 serves as a first insertion space 15, and the space below the receiving portion 13 serves as a second insertion space 16. In the inner circumferential surface of the holding portion 12, a portion forming the first insertion space 15 serves as a first inner circumferential surface 12c, and a portion forming the second insertion space 16 serves as a second inner circumferential surface 12d. The first insertion space 15 and the second insertion space 16 communicate with each other through the through-hole 14. In the window support part 4, the fixing portion 11, the holding portion 12, and the receiving portion 13 are integrally formed, for example.

A sleeve member 17 and a protective window 18 are disposed in the second insertion space 16.

The sleeve member 17 is formed in an annular shape whose axial direction coincides with the vertical direction. The sleeve member 17 is made of a material whose thermal expansion coefficient is smaller than that of the window support part 4, such as Kovar. The thermal expansion coefficient of the sleeve member 17 is within a range of, e.g., 4.9×10-6/° C. to 6.2×10-6/C. Further, it is desirable that the sleeve member 17 is made of a material whose thermal expansion coefficient is close to that of the protective window 18.

The sleeve member 17 is substantially entirely inserted into the second insertion space 16 in a state where the upper surface thereof is in contact with the second receiving surface 13b, and the bottom surface thereof is positioned on the same plane as the tip end surface 12b of the holding portion 12 or is positioned slightly below the tip end surface 12b. When the sleeve member 17 is inserted into the second insertion space 16, an outer circumferential surface 17a thereof is in contact with the second inner circumferential surface 12d of the holding portion 12. The sleeve member 17 is bonded to the holding portion 12 by, e.g., welding. However, the sleeve member 17 and the holding portion 12 may be bonded by brazing, a heat-resistant adhesive, or the like.

The protective window 18 is formed in a cylindrical shape whose axial direction coincides with the vertical direction. The protective window 18 is made of, e.g., sapphire glass. The thermal expansion coefficient of the protective window 18 is smaller than that of the window support part 4 and larger than that of the sleeve member 17. For example, it is within a range of 7.0×10⁻⁶/° C. to 7.7×10⁻⁶/° C.

The outer diameter of the protective window 18 is larger than the diameter of the through-hole 14, and is substantially the same as or slightly smaller than the inner diameter of the sleeve member 17. The protective window 18 is inserted into the sleeve member 17 in a state where the outer peripheral portion of the upper surface is in contact with the second receiving surface 13b, and the lower end thereof projects downward from the holding portion 12. The outer circumferential surface 18a of the protective window 18 is bonded to an inner circumferential surface 17b of the sleeve member 17 by, e.g., silver brazing. However, the sleeve member 17 and the protective window 18 may be bonded by a low melting point glass, a heat resistant adhesive, or the like.

A fiber probe 19 is disposed in the outer case 2. The fiber probe 19 is made of, e.g., a metal material, and has a cylindrical portion 20 whose axial direction coincides with the vertical direction, and a collar portion 21 continuous to the upper end of the cylindrical portion 20. The outer diameter of the collar portion 21 is larger than that of the cylindrical portion 20. The upper surface of the collar portion 21 serves as a pressed surface 21a.

An optical fiber 23 is inserted and held in the fiber probe 19. One end 23a of the optical fiber 23 is inserted into the cylindrical portion 20, and a bent portion 23b continuous to the one end 23a is bent, e.g., at a substantially right angle, inside the collar portion 21. In the optical fiber 23, a portion between the bent portion 23b and the other end serves as an intermediate portion 23c, and the intermediate portion 23c passes through the notch 9a to be located outside the fiber probe 19 from the outer circumferential surface of the collar portion 21. A detector (not shown) or the like is connected to the other end of the optical fiber 23. An end surface (bottom surface) of one end 23a of the optical fiber 23 serves as an incident surface 23d into which infrared light is incident.

The cylindrical portion 20 of the fiber probe 19 is inserted into the shaft part 5 and a tip end thereof is inserted into and supported by the first insertion space 15 of the holding portion 12. The outer circumferential surface of the cylindrical portion 20 is in contact with the first inner circumferential surface 12c of the holding portion 12, and a tip end surface (bottom surface) 19a of the fiber probe 19 is in contact with the first receiving surface 13a of the receiving portion 13. In this case, the center of the optical fiber 23 (the incident surface 23d) substantially coincides with the center of the through-hole 14. Since the fiber probe 19 is disposed inside the window support part 4 in a state where the outer circumferential surface of the cylindrical portion 20 is in contact with the first inner circumferential surface 12c of the holding portion 12, the stable arrangement state of the fiber probe 19 is obtained without shaking against the window support part 4.

The collar portion 21 is disposed in the placing part 6. In a state where the lid part 7 is attached to the placing part 6, an elastic member 22 is disposed between the bottom surface of the adjusting screw 10 and the pressed surface 21a of the collar portion 21.

For example, a compression coil spring is used as the elastic member 22. The fiber probe 19 is pressed downward by the pressing force of the elastic member 22. Therefore, the tip end surface 19a of the fiber probe 19 is pressed against the first receiving surface 13a of the receiving portion 13 by the pressing force of the elastic member 22. Alternatively, a disc spring, a plate spring, or the like may be used as the elastic member 22, and the elastic member 22 may be made of a rubber material or the like.

In the temperature sensor 1, the pressing force of the elastic member 22 with respect to the fiber probe 19 can be adjusted by rotating the adjusting screw 10 and changing the screwing position thereof with respect to the screw hole 7a. Further, the temperature sensor 1 may not include the elastic member 22.

When the temperature sensor 1 configured as described above is attached to a molding machine such as an injection molding machine and used to measure a temperature of molten resin, the temperature measurement is performed by transmitting infrared light that has passed through the protective window 18 and has been incident on the optical fiber 23 to the detector through the optical fiber 23. In this case, the temperature sensor 1 is heated by, e.g., heat generated in an injection molding machine, and the heated parts are expanded.

The temperature sensor 1 includes the sleeve member 17 formed in an annular shape and having the inner circumferential surface 17b in contact with the outer circumferential surface 18a of the protective window 18 and the outer circumferential surface 17a in contact with the second inner circumferential surface 12d of the holding portion 12 of the window support part 4. Since the sleeve member 17 is disposed between the protective window 18 and the window support part 4, the inflow of molten resin into the gap between the protective window 18 and the window support part 4 is suppressed, and an excessive force is less likely to be applied to the protective window during cooling of the temperature sensor 1. Hence, damage to the protective window can be prevented.

Further, in the temperature sensor 1, the thermal expansion coefficient of the protective window 18 is smaller than that of the window support part 4, and the thermal expansion coefficient of the sleeve member 17 is smaller than that of the protective window 18. Thus, the degree of expansion of the sleeve member 17 becomes smaller than that of the protective window 18, and the protective window 18 is tightened by the sleeve member 17. Accordingly, the molten resin cannot enter the gap between the protective window 18 and the sleeve member 17, which makes it possible to reliably prevent the molten resin from entering the gap between the protective window 18 and the sleeve member 17.

Further, the protective window 18 is made of sapphire glass, and the sleeve member 17 is made of Kovar. Therefore, the thermal expansion coefficient of the sleeve member 17 becomes close to but smaller than that of the protective window 18, and the degree of expansion of the protective window 18 and that of the sleeve member 17 become similar. Accordingly, in a state where the protective window 18 is tightened by the sleeve member 17 during expansion, the close contact between the protective window 18 and the sleeve member 17 can be maintained without applying an excessive load from the sleeve member 17 to the protective window 18.

Further, the lower end of the protective window 18 projects downward from the holding portion 12. Therefore, the molten resin is less likely to remain at the tip end of the temperature sensor 1 during measurement, and an excessive pressure is less likely to be applied from the molten resin to the protective window 18.

Further, in the above-described temperature sensor 1, the window support part 4 has the receiving portion 13, and the first receiving surface 13a and the second receiving surface 13b are in contact with the fiber probe 19 and the protective window 18, respectively. Thus, the pressing force of the elastic member 22, which is applied to the fiber probe 19, is less likely to be transmitted to the protective window 18. Further, when the pressure of the molten resin is applied to the protective window 18, the pressure of the molten resin is transmitted from the protective window 18 to the outer case 2 through the receiving portion 13, so that the load caused by the pressure of the molten resin on the protective window 18 can be reduced.

In the temperature sensor where infrared light is incident on the optical fiber through the protective window, if an air layer exists between the protective window and the incident surface, the light may be reflected at the interface between the protective window and the air layer or at the interface between the air layer and the incident surface depending on conditions of the air layer, which may result in optical interference. The optical interference occurs when the air layer has an extremely small thickness on the order of nanometers to micrometers. For example, if the thickness of the air layer changes due to thermal expansion of the protective window, the degree of optical interference also changes, which may affect the result of temperature measurement by the sensor.

In the above-described temperature sensor 1, the window support part 4 has the receiving portion 13, so that a certain distance is maintained between the upper surface of the protective window 18 and the incident surface 23d of the optical fiber 23 with the air layer (the through-hole 14) interposed therebetween. Since the receiving portion 13 is a structure, the thickness of the air layer is not on the order of nanometers or micrometers, but on the order of millimeters or more. Accordingly, a certain distance can be maintained between the optical fiber 23 and the protective window 18 by the receiving portion 13, and a stable measurement state can be ensured while suppressing the occurrence of optical interference.

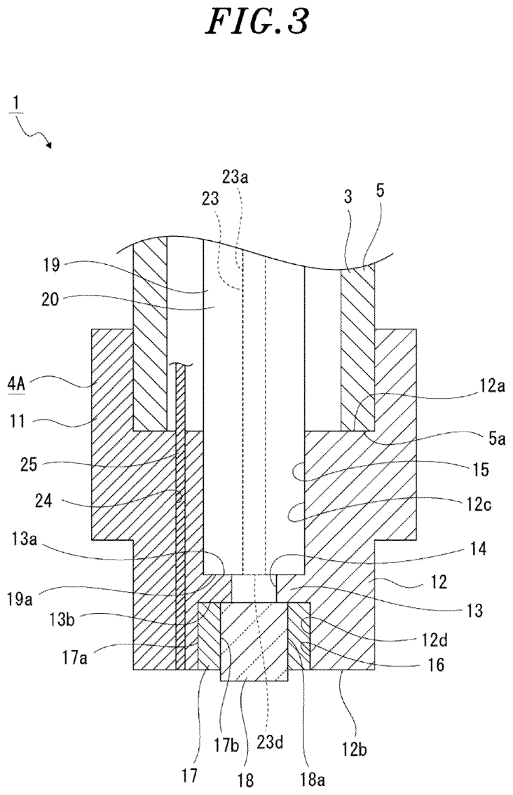

In addition, in the temperature sensor 1, a window support part 4A having a calibration insertion hole 24 may be used instead of the window support part 4 (see FIG. 3).

The window support part 4A has the calibration insertion hole 24 vertically penetrating through the holding portion 12. A calibration temperature sensor, e.g., a thermocouple 25, is inserted into the calibration insertion hole 24. A sheath type thermocouple is used as the thermocouple 25, for example, and the thermocouple 25 is attached by welding to the window support part 4A in a state where one end thereof is inserted into the calibration insertion hole 24. The other end of the thermocouple 25 is taken out of the outer case 2 from the notch 9a, for example, and is connected to a measuring device (not shown).

By forming the calibration insertion hole 24 in the window support part 4A and attaching the thermocouple 25 to the calibration insertion hole 24, the temperature can be measured using both the optical fiber 23 and the thermocouple 25. Therefore, the measurement result can be calibrated, and the measurement accuracy of the temperature sensor 1 can be improved.

### Temperature Sensor According to Second Embodiment

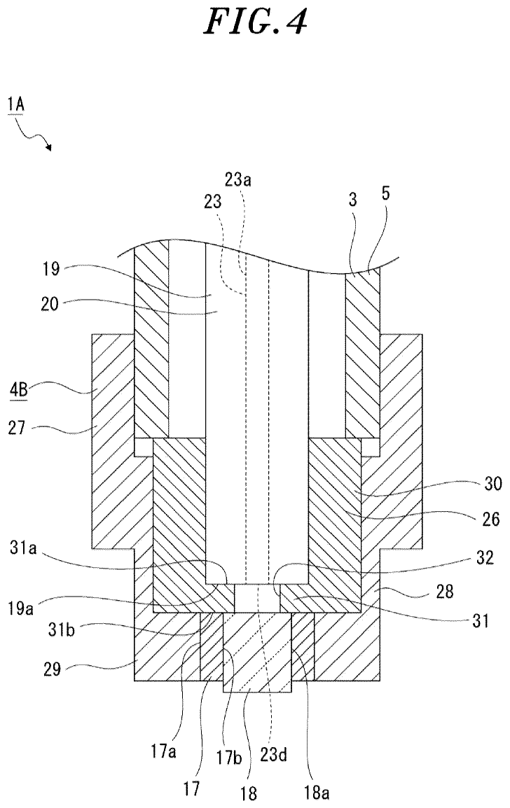

Next, a temperature sensor 1A according to a second embodiment will be described (see FIG. 4).

The temperature sensor 1A to be described below is different from the above-described temperature sensor 1 only in that a window support part 4B and a spacer 26 are used instead of the window support part 4. Therefore, only the differences between with the temperature sensor 1A and the temperature sensor 1 will be described in detail. Like reference numerals will be used for like parts as those of the temperature sensor 1, and redundant description thereof will be omitted.

The window support part 4B has a fixing portion 27, a connecting portion 28, and a holding portion 29 (see FIG. 4). The fixing portion 27, the connecting portion 28, and the holding portion 29 are formed in a cylindrical shape. The connecting portion 28 is continuously disposed from the lower end of the fixing portion 27, and the holding portion 29 is continuously disposed from the lower end of the connecting portion 28. The sleeve member 17 and the protective window 18 are inserted into and supported by the holding portion 29.

The spacer 26 is also supported by the window support part 4B. The spacer 26 is made of, e.g., a metal material, and has a cylindrical portion 30 whose axial direction coincides with the vertical direction, and a receiving portion 31 projecting inward from the lower end of the cylindrical portion 30. The upper surface of the receiving portion 31 serves as a first receiving surface 31a, and the bottom surface thereof serves as a second receiving surface 31b. The inner space of the receiving portion 31 serves as a through-hole 32. The cylindrical portion 30 and the receiving portion 31 are integrally formed, for example.

The tip end of the fiber probe 19 is inserted into the cylindrical portion 30. The outer circumferential surface of the cylindrical portion 20 is in contact with the inner circumferential surface of the cylindrical portion 30. The tip end surface 19a of the fiber probe 19 is in contact with the first receiving surface 31a of the receiving portion 31. The upper surface of the sleeve member 17 and the upper surface of the protective window 18 are in contact with the second receiving surface 31b of the receiving portion 31.

In the temperature sensor 1A, the pressing force of the elastic member 22, which is applied to the fiber probe 19 by the receiving portion 31, is less likely to be transmitted to the protective window 18, and the pressure of the molten resin is transmitted from the protective window 18 to the outer case 2 through the spacer 26.

By providing the receiving portion 31 separately from the window support part 4B, the receiving portion 31 can be made of a material different from that of the window support part 4B. For example, when the receiving portion 31 is made of a material with higher strength, high strength of the receiving portion 31 can be ensured.

1. A temperature sensor used in a molding machine, comprising:
a cylindrical fiber probe into which an optical fiber is inserted;
a window support part formed in a cylindrical shape and into which at least a part of the fiber probe is inserted;
a protective window disposed on a tip end side of the fiber probe while being at least partially inserted into the window support part; and
a sleeve member formed in an annular shape, and having an inner circumferential surface in contact with an outer circumferential surface of the protective window and an outer circumferential surface in contact with an inner circumferential surface of the window support part.

2. The temperature sensor of claim 1, wherein a thermal expansion coefficient of the protective window is smaller than a thermal expansion coefficient of the window support part, and
a thermal expansion coefficient of the sleeve member is smaller than the thermal expansion coefficient of the protective window.

3. The temperature sensor of claim 2, wherein the protective window is made of sapphire glass, and
the sleeve member is made of Kovar.

4. The temperature sensor of claim 1, wherein the window support part has a receiving portion that projects inward,
the receiving portion is disposed between the fiber probe and the protective window, and
the receiving portion has one surface in contact with the fiber probe and the other surface in contact with the protective window.

5. The temperature sensor of claim 2, wherein the window support part has a receiving portion that projects inward,
the receiving portion is disposed between the fiber probe and the protective window, and
the receiving portion has one surface in contact with the fiber probe and the other surface in contact with the protective window.

6. The temperature sensor of claim 3, wherein the window support part has a receiving portion that projects inward,
the receiving portion is disposed between the fiber probe and the protective window, and
the receiving portion has one surface in contact with the fiber probe and the other surface in contact with the protective window.

7. The temperature sensor of claim 1, wherein a calibration insertion hole is formed in the window support part, and
a thermocouple is inserted into the calibration insertion hole.

8. The temperature sensor of claim 2, wherein a calibration insertion hole is formed in the window support part, and
a thermocouple is inserted into the calibration insertion hole.

9. The temperature sensor of claim 3, wherein a calibration insertion hole is formed in the window support part, and
a thermocouple is inserted into the calibration insertion hole.
